(19) United States
(12) Patent Application Publication
(10) Pub. No.: US 2009/0187478 A1
(43) Pub. Date: Jul. 23, 2009

(54) ITEM-BASED SELLER SALES INCENTIVE METHOD

(75) Inventor: Samuel E. Shipley, Ann Arbor, MI (US)

Correspondence Address: SENNIGER POWERS LLP, 100 NORTH BROADWAY, 17TH FLOOR, ST LOUIS, MO, 63102, US

(73) Assignee: MARITZ INC., Fenton, MO (US)

(21) Appl. No.: 12/016,748

(22) Filed: Jan. 18, 2008

(51) Int. Cl. G06Q 30/00

(52) U.S. Cl. 705/14

(57) ABSTRACT

A manufacturer to dealer incentive program allows the manufacturer to incentivize sales of the dealer. The manufacturer allocates credits to the dealer for vehicles sold by the dealer, and the dealer assigns the credits to individual vehicles in the dealer's inventory. When a sales person of the dealer sells a particular vehicle having credits assigned to it, the manufacturer provides an incentive to the sales person as a function of the number of credits assigned to the particular vehicle.

### BACKGROUND

Automobile manufacturers desire ways to predict the needed supply of each item produced by the manufacturer. Automobile dealers desire ways to entice sales person to push particular vehicles in the dealer's inventory. Dealers entice sales person to sell a particular vehicle or group of vehicles by offering additional commissions or bonuses on the vehicle that the dealer desires to sell. However, manufacturers are not aware of these incentives being offered by dealers. This negatively impacts the manufacturer's ability to predict how many vehicles of what type are needed by each dealer that the manufacturer supplies. This also means that dealers have full control of which vehicles are sold, and the manufacturer has no influence over which vehicles are sold.

### SUMMARY

In one embodiment, the invention is a method for incentivizing a sales staff of a seller to sell particular items in an inventory of the seller. A manufacturer of the items in the inventory allocates a credit to the seller for each item sold out of the inventory of the seller during a first program period. At the conclusion of the first program period, the seller assigns each of the allocated credits to items remaining in the inventory of the seller. The manufacturer may optionally preclude the seller from assigning the credits to certain items in the inventory. The seller may assign more than one credit to an item, up to a predetermined maximum number of credits, or until the allocated credits are all assigned. The seller receives an incentive from the manufacturer for selling items having credits assigned to them. The incentive provided for each item is a predetermined amount of money per credit assigned to the item. In one embodiment, the incentive is provided to a sales person of the seller responsible for selling the item having the credits assigned to the item.

In one embodiment, a manufacturer allocates a predetermined amount of credits to a seller. The seller assigns a quantity of the predetermined amount of credits to each item in an inventory of the seller. The seller receives an incentive from the manufacturer for selling items having credits assigned to them. The incentive provided for each item is a predetermined amount of money per credit assigned to the item. In another embodiment, the amount of money per credit varies as a function of the item to which the credit is assigned.

In one embodiment, the incentive is provided to a sales person of the seller responsible for selling the item having the credits assigned to the item.

In one embodiment, the invention comprises computer executable instructions for implementing a method of incentivizing a seller. A database component operates on a server to store a plurality of identifiers, each identifier corresponding to an item in the inventory of a seller. The database component also stores credit data indicting how many credits are allocated to the seller that have not been assigned to an item in the inventory by the seller, and assignment data indicating how many credits are assigned to each item in the inventory. A seller interface component enables a seller to enter sales data into the database component and assign credits to items in the inventory. A report component queries the database to generate reports for the manufacturer and seller indicating credits assigned to items sold and not sold by the seller.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Other features will be in part apparent and in part pointed out hereinafter.

### BRIEF DESCRIPTION OF THE DRAWINGS

FIG. 1 is a flow chart of a method for incentivizing a seller according to one embodiment of the invention.

FIG. 2 is a block diagram of a system for administering an incentive program according to one embodiment of the invention.

FIG. 3 is a screen shot of a seller interface for assigning credits according to one embodiment of the invention.

Corresponding reference characters indicate corresponding parts throughout the drawings.

### DESCRIPTION

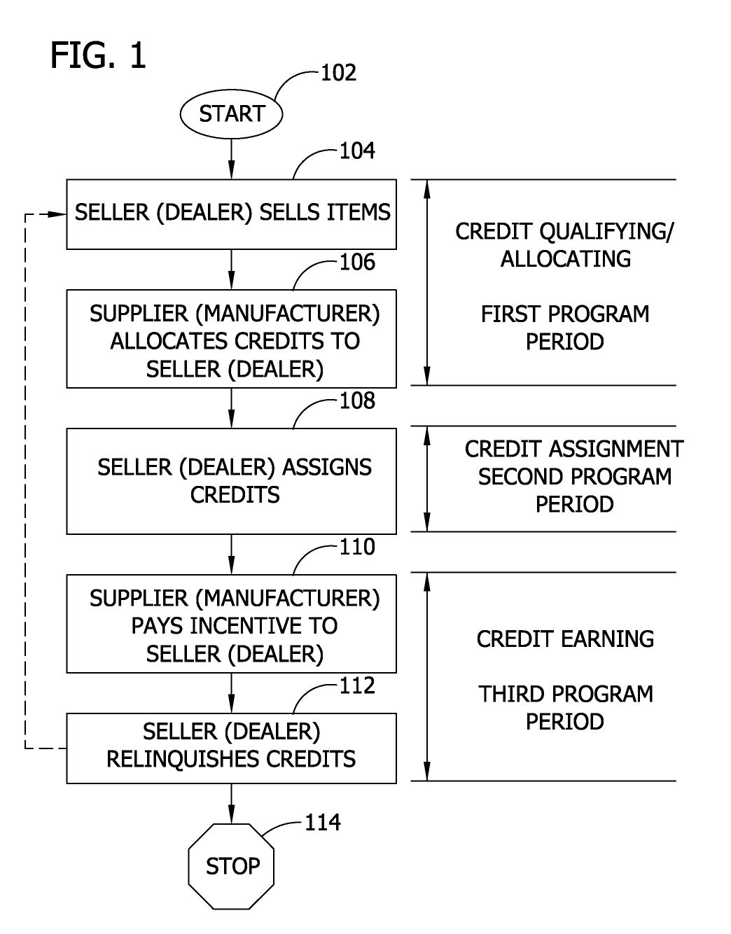

Referring to FIG. 1, a method in which a supplier (e.g., an automotive manufacturer) incentivizes one or more of its sellers (e.g., automobile dealers according to one embodiment of the invention). In particular, the supplier incentivizes sellers and their sales people by providing redeemable credits for inventory sales.

Initially, the method begins at 102 with the supplier providing an inventory of items (e.g., vehicles) to the dealer. At 104, the dealer's sales people sell vehicles from the inventory provided the dealer during a first program period. During this first program period the dealer earns a predetermined number of credits for each vehicle sold from the inventory, and the credits earned are tracked by a system including a database during the first program period. The first program period may last, for example, for two weeks. At 106, the first program period concludes, and the manufacturer allocates a quantity of credits to the dealer based on or equal to the number of vehicles that the dealer sold during the first program period. Alternatively, the manufacturer may allocate credits to the dealer as the vehicles are sold and the credits are earned during the first program period. Thus, the first period is a period during which the dealer qualifies for credits and the supplier allocates credits to the dealer. In one embodiment, the seller allocates credits to the dealer as a function of the individual vehicle or type of vehicle sold. That is, the dealer receives 1 credit for selling a vehicle that has been in the dealer's inventory for one week, and the dealer receives 3 credits for selling a vehicle that has been in the dealer's inventory for 3 weeks. A vehicle has a type or belongs to a group if the vehicle has the one or more characteristics defining the group or type. For example, a type may include all vehicles having a certain model year characteristic, or all vehicles having a particular make characteristic such as a Dodge Ram or trucks. Characteristics defining a group may include a length of time the vehicle has been in the dealer's inventory (e.g., more than 2 weeks or more than a month) or a division designing the vehicle (e.g., special edition vehicles).

During a second program period beginning at 108, the dealer assigns the earned credits to vehicles remaining in the inventory of the dealer so that the second period is a period during which credits are assigned by the seller to specific vehicles in the inventory of the seller. If, at any time during the second program period, it turns out that a sales person of the dealer sold a vehicle having credits assigned to it, the credits may be assigned to another vehicle in the inventory of the dealer. If the sales person sells a vehicle having credits assigned to it at or near the end of the second program period, the dealer may have a grace period (e.g., 2 days) to assign the credits to another vehicle in the inventory of the dealer. The dealer relinquishes (i.e., the manufacturer revokes) any credits not assigned to a vehicle during the second program period (or the applicable grace period).

At 110, a third program period begins during which the dealer and/or the sales people of the dealer can earn the credits by selling vehicles having credits which were assigned to the vehicle during the second program period. In one embodiment, the incentive paid by the manufacturer for each credit is a predetermined amount of money (e.g., 250 dollars), and the dealer may assign a maximum of four credits to each vehicle in the dealer's inventory. A sales person who sells a vehicle receives the incentive assigned to the vehicle. In one embodiment, the manufacturer has access to a database including the credits assigned to each vehicle and therefore knows what vehicles the dealer is most likely to sell during the third program period. At 112, the third program period concludes, and the dealer relinquishes (i.e., the manufacturer revokes) any credits assigned to a vehicle that was not sold during the third program period, and the method ends at 114. Optionally, the manufacturer may choose to restart the incentive program at 104. In one embodiment, the first program period is several weeks or months (e.g., 2 weeks) and the second program period and the third program period are each one week in duration.

In one example of a practical application of the method of FIG. 1, sales people of an automobile dealer sells 12 vehicles during a first program period, 10 of which are eligible for credits. The automobile manufacturer therefore allocates 10 credits to the dealer during the first program period. During a second program period, the dealer assigns 1 credit to a first vehicle in the dealer's inventory, 2 credits to a second vehicle, 2 credits to a third vehicle, and 4 credits (the maximum allowed by the manufacturer) to a fourth vehicle. However, a sales person of the dealer sells the fourth vehicle during the second program period, and the dealer does not reassign the credits within 2 days of the sale as allowed by the manufacturer. Therefore, during the third program period, the dealer has 5 credits that are unassigned to vehicles in the dealer's inventory and will be revoked at the end of the third program period. The manufacturer values each credit at 500 dollars such that the potential incentive to the dealer is 2500 dollars; 500 dollars for selling the first vehicle, 1000 dollars for selling the second vehicle, and 1000 dollars for selling the third vehicle. During the third program period, a first sales person sells the first and second vehicles, earning 1500 dollars from the manufacturer. The third vehicle is not sold during the third program period, and the 2 credits assigned to third vehicle are relinquished by the dealer (i.e., revoked by the manufacturer). If the manufacturer chose to restart the incentive program, the dealer would begin another first program period, starting with zero credits.

It is contemplated that the manufacturer may put limits on the incentive program embodied in the method of FIG. 1. For example, during the second program period of assigning credits, the manufacturer can require the seller to allocate credits to only certain vehicles or types of vehicles. Similarly, the manufacturer may prevent or limit the dealer from assigning credits to certain vehicles or types of vehicles. In contrast, during the first program period of qualifying for credits by the seller and allocating credits by the manufacturer, the manufacturer may disqualify the sale of certain vehicles or types of vehicles from earning any credits, or allocate additional credits to certain vehicles or types of vehicles.

In another embodiment of the invention, the manufacturer allocates a predetermined number of credits to the dealer during the first program period. This predetermined number can be an arbitrary number or based on some previous action by the dealer or its sales people. The dealer assigns the credits to vehicles in the inventory of the dealer during the second program period, and the manufacturer pays the assigned credits to the dealer and/or the sales people for each vehicle sold during the third program period.

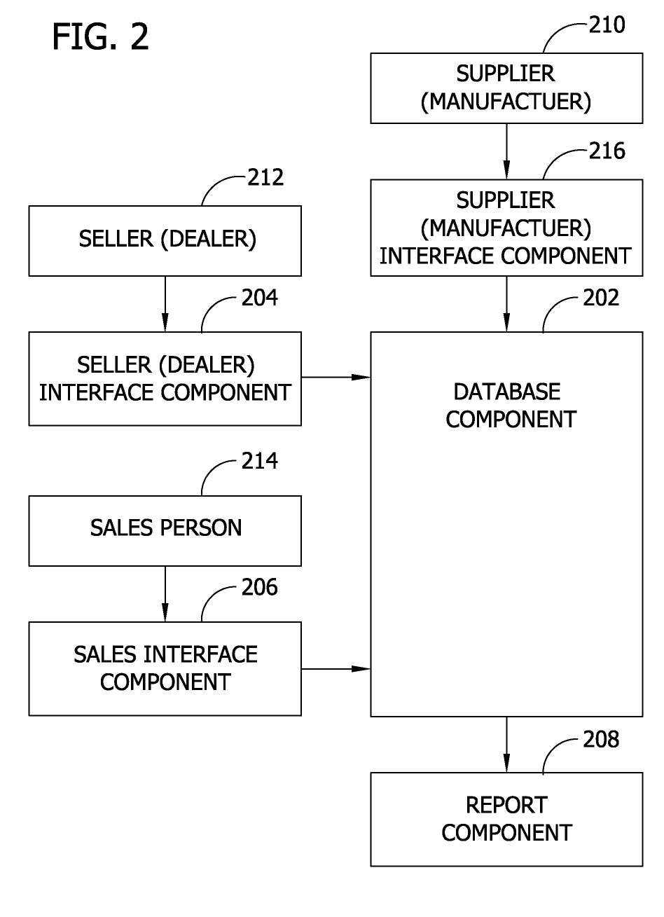

Referring to FIG. 2, computer executable components for implementing the method shown in FIG. 1 include a database component 202, a seller interface component 204, a sales person interface component 206, a supplier interface component 216, and a report component 208. The database component 202 stores data including a plurality of identifiers, each identifier unique to a particular item (e.g., vehicle identification number and/or serial number), each corresponding to a vehicle in the inventory of the dealer. In addition, the database component 202 stores credit data indicative of how many credits are allocated to the seller and are not assigned to a vehicle in the inventory of the dealer, and assignment data indicative of how many credits are assigned to each vehicle in the inventory of the dealer. The unique identifier identifies only one item and not a plurality of items or a class of items. For example, if the dealer has 10 vehicles of the same make, model number, options and color in inventory, each vehicle will be assigned a unique identifier.

In one embodiment, the seller interface 204 receives an inventory status file (e.g., a new vehicle delivery record file) from the seller 212 reporting vehicles in the inventory of the seller 212 and vehicles sold from the seller's inventory. The inventory status file may be provided to the database 202 daily, or at some other interval. For example, if the first program period is 2 weeks, the second program period is 1 week, and the third program period is 1 week, then the inventory status file may be provided by the seller 212 weekly. The seller interface component 204 also provides a graphical user interface through which the dealer 212 can view credit data and review and edit assignment data. In one embodiment, the inventory status file is used to conduct an audit after the third program period ends (e.g., 90 days later). The audit determines whether any vehicles (i.e., items) for which an incentive was paid to the seller were returned to the seller. If an item for which an incentive was paid has been returned, the seller can take an appropriate action (e.g., revoking the incentive, offsetting the incentive, and/or removing the seller from the incentive program).

The database component 202 determines the stored assignment data and credit data each time it receives input from a dealer via a new inventory status file or the graphical user interface. It is contemplated that all information may be provided from the dealer 212 to the manufacturer 210 through complete files such that a graphical user interface is not necessary. It is also contemplated that all data may be entered through the graphical user interface such that the seller interface component 204 does not need to accept inventory status files. Regardless of how the data is received by the seller interface component 204, the database component 202 processes the data to update the credit data and the sales data stored by the database component 202. The data provided by the dealer 212 to the database component 202 includes a listing of vehicles in the inventory of the dealer, vehicles sold by the dealer since the last inventory update, and the sales person responsible for any vehicle sold since the last inventory update.

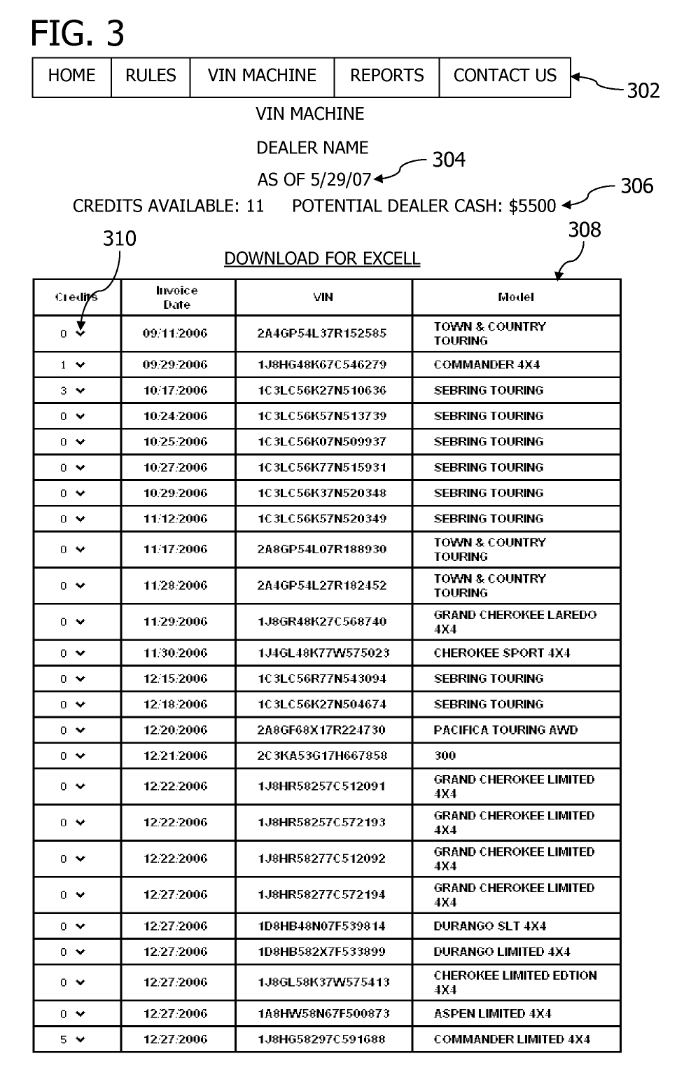

In operation, the database component 202 includes data for a plurality of dealers. A seller 212 (e.g., a dealer) uses an Internet browser to log on to a server having the computer executable components shown in FIG. 2. The log-on information identifies the dealer 212 to the database component 202, and the seller interface 204 presented to the dealer 212 via the dealer's Internet browser includes only information related to that particular dealer. One example of a screen shot of a graphical user interface presented to a dealer 212 by the seller interface component 204 is shown in FIG. 3. As described above, the dealer 212 may use the seller interface component 204 to report sales data to the database component 202. Additionally, the dealer 212 may use the sales interface component 204 to view data such as credits allocated to the dealer 212, credits assigned by the dealer 212 to each vehicle in the dealer's inventory, and potential incentives available based on the number of allocated credits. The dealer 212 may also view data for prior program periods (e.g., an expired third program period) to, for example, determine which types of vehicles the incentive program is most effective for before assigning credits in an upcoming or current second program period.

Referring to FIG. 3, one example of a screen presented to the dealer 212 upon log on shows the dealer 212 an overview of information relevant to the dealer 212. A header 302 contains a set of links (e.g., links to incentive program rules and an interface for report component 208). The links allow the dealer 212 to access different operations of the seller interface component 204. For example, a relevancy date 304 tells the dealer when the information relevant to the dealer 212 was last updated in the database component 202. A credits status display 306 informs the dealer 212 of the quantity of credits allocated to the dealer 212 (e.g., 11 in the present example), and the amount of a potential dealer incentive (e.g., 5500 dollars in the present example wherein each of the available credits is valued at 500 dollars). In one embodiment, the credits status display 306 may also inform the dealer 212 as to the number of credits allocated to the dealer 212 but currently unassigned to a vehicle in the dealer's inventory. An inventory listing 308 displays a list of individual vehicles in the dealer's inventory identified by vehicle identification number that are eligible to have credits assigned to them, and the number of credits assigned to each listed vehicle. The inventory listing 308 in the example provides the dealer 212 with a drop down menu associated with each listed vehicle identification number that enables the dealer 212 to adjust the number of credits assigned to each vehicle.

Referring again to FIG. 2, when an individual sales person 214 logs on to the server via an Internet browser, the sales person interface 206 provides the sales person 214 with data relevant to that sales person. For example, the sales person 214 does not need to see options for assigning credits to vehicles in the dealer's inventory. The sales person 214 is presented with a list of identifiers (e.g., vehicle identification numbers) and a corresponding number of credits associated with each identifier. The sales person 214 may also be able to see incentives earned by the sales person 214 in the current sales cycle, or a previous promotion period. For example, during a first program period and a second program period, the sales person 214 is shown credits (e.g., incentives) earned by the sales person 214 during a previous promotion (i.e., during a prior third program period). In contrast, during a third program period, the sales person 214 is shown credits (e.g., incentives) earned to date by the sales person 214 during the current third program period. In addition, the sales person 214 is shown credits (e.g., incentives) which could be earned by the sales person 214 during the current third program period for the sale of particular items (e.g., vehicles) in inventory. This incentivizes the sales person to sell items with the highest assigned credits. The supplier interface component 216 for use by the supplier 210 permits the supplier to allocate credits to the seller and designate which items earn credits, and which are eligible for assignment of credits.

The report component 208 queries the database component 202 and creates reports for various entities including the seller 212 (e.g., dealer), the supplier 210 (e.g., manufacturer), and others such as regional divisions or distributors. The reports generally include data indicating vehicles in the inventory of any relevant dealers and vehicles sold from the inventory of any relevant dealers during a predetermined time period, but may be customized as needed to include any information that can be derived from the data reported to and stored by the database component 202. For example, at the end of a third program period, the report component 208 provides the dealer 212 with a report listing the vehicles by vehicle identification number having credits assigned to them along with a status of the vehicle (i.e., whether the vehicle was sold during the third program period). As another example, at the end of a first program period, the report component 208 provides the manufacturer 210 with a report listing sales districts, vehicles sold by dealers in each district, and credits allocated to dealers in each district.

The supplier interface component 216 enables the supplier 210 (i.e., manufacturer) to view current or past data stored by the database component 202 and change program rules (e.g., eligible vehicles) within the database component 202. The supplier 210 may view data such as vehicles eligible for credits at dealers within each sales region along with credits allocated to the dealers within each region (i.e., district). The supplier 210 may also change which vehicles or classes of vehicles are eligible for credits to participating dealers, and which vehicles or classes of vehicles may have credits assigned to them by the dealers. The supplier 210 may also alter the length and/or dates of the first, second, and third program periods.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

Embodiments of the invention may be implemented with computer-executable instructions. The computer-executable instructions may be organized into one or more computer-executable components or modules. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

What is claimed is:

1. (from the perspective of the supplier) A method for use by a supplier for incentivizing a seller and/or the seller's sales person to sell a plurality of items of the supplier in an inventory of the seller, said method comprising:
allocating credits to the seller;
receiving from the seller an assignment of a quantity of the allocated credits to a selected individual item in the inventory; and
providing an incentive to the seller in response to the seller selling the selected item, said incentive being a function of the quantity of credits assigned to the selected item.

2. The method of claim 1 wherein:
allocating credits occurs during a first program period;
receiving the assignment occurs during a second program period; and
providing the incentive occurs during a third program period.

3. The method of claim 2 wherein the first, second, and third program periods are sequential and do not overlap.

4. The method of claim 2 wherein the second and third program periods overlap; said method further comprising:
revoking credits allocated to the seller during the first program period, wherein said revoked credits were not assigned to items that sold during the third program period;
allocating credits to the seller for items sold during the third program period;
receiving an assignment of the credits allocated during the third program period to items in the inventory during a fourth program period; and
providing an incentive to the seller for items sold during a fifth program period having credits assigned to said sold items.

5. The method of claim 2 further comprising revoking the credits assigned to the selected item at a conclusion of the third program period in response to the seller failing to sell the selected item during the third program period, and revoking any credits not assigned to an item in the inventory of the seller at the conclusion of the third program period.

6. The method of claim 1 wherein allocating credits to the seller comprises allocating one credit to the seller for each item the seller sells from the inventory of the seller and wherein providing the incentive comprises paying a predetermined amount for each credit assigned to the sold selected item.

7. The method of claim 1 wherein allocating credits to the seller comprises allocating credits to the seller as a function of a characteristic of the sold selected item, wherein the characteristic is one of the following: an identity of the item, a length of time the item has been in the inventory of the seller, a type of the item, or a group to which the item belongs.

8. The method of claim 1 wherein providing the incentive to the seller comprises paying a predetermined amount for each credit assigned to the sold selected item, wherein the predetermined amount is a function of a characteristic of the sold selected item to which the quantity of credits are assigned, wherein the characteristic is one of the following: an identity of the item, a length of time the item has been in the inventory of the seller, a type of the item, or a group to which the item belongs.

9. The method of claim 1 wherein:
no more than a predetermined number of credits are assigned to any item in the inventory, wherein said predetermined number of credits is set by the supplier;
the incentive is equal to a multiple of the quantity of credits assigned to the selected item;
the incentive provided for each credit is a predetermined amount of money;
the selected item is a vehicle;
the seller is an automobile dealer;
the incentive is provided to a sales person of the seller who sells the selected item; and
each item in the inventory is identified by at least one of the following: a vehicle identification number or a serial number.

10. The method of claim 1 wherein:
allocating credits to a seller comprises allocating a predetermined quantity of credits to the seller;
receiving an assignment comprises receiving an assignment of one credit to each of a quantity of items in the inventory of the seller, wherein said quantity of items is equal to the predetermined quantity of allocated credits; and
providing an incentive comprises providing an incentive to a sales person of the seller as a function of a quantity of items sold by the sales person, each of said quantity of sold items having one credit assigned to said item.

11. (from the perspective of the seller) A method in which a seller of items from a supplier acquires incentives from the supplier, said method comprising:
receiving credits from the supplier in response to selling items from the supplier from an inventory of the seller;
assigning a quantity of the received credits to a selected individual item of the supplier in the inventory of the seller; and
receiving an incentive in response to selling the selected item, said incentive being a function of the quantity of credits assigned to the selected item.

12. The method of claim 11 wherein the received credit is provided by a manufacturer of the item and the received incentive is paid by a manufacturer of the item.

13. The method of claim 11 wherein:
receiving credits occurs during a first program period;
assigning the received credits occurs during a second program period; and
receiving the incentive occurs during a third program period.

14. The method of claim 13 wherein the first, second, and third program periods are sequential and do not overlap.

15. The method of claim 13 wherein the second and third program periods overlap; said method further comprising:
relinquishing credits received during the first program period, wherein said relinquished credits were not assigned to items that sold during the third program period;
receiving credits for items sold during the third program period;
assigning the credits received during the third program period to items in the inventory during a fourth program period; and
receiving an incentive in response to selling items in the inventory during a fifth program period having credits assigned to said sold items.

16. The method of claim 13 further comprising relinquishing the credits assigned to the selected item at a conclusion of the third program period in response to failing to sell the selected item, and relinquishing any credits not assigned to an item in the inventory of the seller at the conclusion of the third program period.

17. The method of claim 11 wherein receiving credits comprises receiving one credit for each item sold from the inventory of the seller and wherein receiving an incentive comprises receiving a predetermined amount for each credit assigned to the sold selected item.

18. The method of claim 11 wherein receiving credits comprises receiving credits from the supplier as a function of a characteristic of the sold selected item, wherein the characteristic is one of the following: an identity of the item, a length of time the item has been in the inventory of the seller, a type of the item, or a group to which the item belongs.

19. The method of claim 11 wherein the incentive received for each credit of the quantity of credits is a predetermined amount, wherein the predetermined amount is a function of a characteristic of the selected item to which the quantity of credits are assigned, wherein the characteristic is one of the following: an identity of the item, a length of time the item has been in the inventory of the seller, a type of the item, or a group to which the item belongs.

20. The method of claim 13 wherein:
no more than a predetermined number of credits are assigned to any item in the inventory, wherein said predetermined number of credits is set by the supplier;
the incentive is equal to a multiple of the quantity of credits assigned to the selected item;
the incentive provided for each credit is a predetermined amount of money;
the predetermined amount of money is 500 dollars;
the selected item is a vehicle;
the seller is an automobile dealer;
the incentive is paid to a sales person of the seller who sells the selected item; and
each item in the inventory is identified by at least one of the following: a vehicle identification number or a serial number.

21. One or more tangible computer-readable storage media having computer-executable components for implementing an incentive program wherein a supplier allocates a credit to a seller for each item sold from an inventory of the seller during a first program period, the seller assigns each allocated credit to an item in the inventory, and the supplier pays an incentive to the seller for each credit assigned to an item in the inventory of the seller that is sold during a second program period, said computer-executable components comprising:
a supplier interface component for use by the supplier for designating items or groups of items in the inventory of the seller for which the supplier allocates a credit to the seller upon the sale of the designated item by the seller and for designating items or groups of items in the inventory of the seller that are eligible to have credits assigned to them by the seller;
a database component for storing a plurality of identifiers, each of said identifiers corresponding to an individual item in the inventory of the seller, credit data indicating how many of the allocated credits are unassigned to an item in the inventory of the seller, and assignment data indicating how many credits are assigned to each individual item in the inventory; and
a seller interface component for receiving from the seller an assignment of credits allocated to the seller to items of the supplier in the inventory of the seller, wherein the database component determines the credit data and assignment data from the assignment of credits received from the seller.

22. The computer-readable storage media of claim 21 wherein the seller interface component queries the database component, displays the credit data to the seller, and enables the seller to assign each unassigned credit to an item in the inventory of the seller; wherein the computer-executable components of the computer readable storage media further comprise a sales interface component for use by a sales person of the seller, said sales interface for querying the database component and for displaying at least one identifier corresponding to a first item in the inventory of the seller and assignment data corresponding to the first item.

23. The computer-readable storage media of claim 22 wherein the sales interface component displays a list of identifiers along with assignment data corresponding to each of the identifiers in the list and sales data for a sales person accessing the sales interface component.

24. The computer-readable storage media of claim 21 wherein the seller interface component enables the seller to assign more than one credit to the same item in the inventory, and wherein the seller interface component does not allow the seller to assign more than a predetermined number of credits to any item in the inventory.

25. The computer-readable storage media of claim 21 further comprising a report component for querying the database component and providing a report to the supplier indicating the number of credits assigned to items sold by the seller.

26. The computer-readable storage media of claim 21 wherein the seller interface component enables the seller to report sales data, said sales data comprising a date of sale, a responsible sales person, and the identifier for each item sold from the inventory of the seller.

27. (from the perspective of both the supplier, the seller and sales person) A method for use by a supplier for incentivizing a sales person of a seller to sell an item of the supplier in an inventory of the seller, said method comprising:
qualifying by a seller for credits from the supplier based on sales by the sales by the sales person during a predetermined period of time;
allocating by the supplier to the seller the qualified credits;
assigning by the seller a quantity of the allocated credits to each selected individual item of the supplier in the inventory of the seller; and
providing an incentive to the sales person of the seller in response to the sales person selling one or more of the selected items during a predefined period of time, said incentive being a function of the quantity of credits assigned to the sold selected items.
